(19) United States
(12) Patent Application Publication
(10) Pub. No.: US 2024/0300382 A1
(43) Pub. Date: Sep. 12, 2024

(54) ELECTRIC VEHICLE CHARGING SYSTEM WITH BATTERY TEMPERATURE OPTIMIZATION USING CHARGING STATION

(71) Applicant: EVJAM LLC, Minneapolis, MN (US)

(72) Inventors: Steven DICKE, Minneapolis, MN (US); Gregg KROMREY, Hudson, WI (US)

(73) Assignee: EVJAM LLC, Minneapolis, MN (US)

(21) Appl. No.: 18/599,179

(22) Filed: Mar. 7, 2024

Related U.S. Application Data
(60) Provisional application No. 63/450,522, filed on Mar. 7, 2023.

(51) Int. Cl. B60L 58/26; B60L 53/62; B60L 58/27

(52) U.S. Cl. CPC B60L 58/26; B60L 53/62; B60L 58/27

(57) ABSTRACT

One aspect provides a method of charging a battery of an electric vehicle including plugging the electric vehicle into a charging station, measuring a temperature of the battery, and adjusting the temperature of the battery to be within a charging temperature range using power from the charging station.

### CROSS REFERENCE TO RELATED APPLICATION

This Non-Provisional Patent Application claims the benefit of the filing date of U.S. Provisional Patent Application Ser. No. 63/450,522, filed Mar. 7, 2023, which is herein incorporated by reference.

### TECHNICAL FIELD

The present disclosure relates generally to examples of electric vehicles and to devices for use with an electric vehicle, including electric vehicle batteries and electric vehicle charging systems and devices.

### BACKGROUND

Electric vehicles and electric vehicle devices provide quiet, clean, and efficient powertrains for moving from place to place or for getting work done.

For these and other reasons, there is a need for the present invention.

### SUMMARY

The present disclosure provides one or more examples of an electric vehicle and systems and/or devices for use with an electric vehicle. In one or more examples, the system is an electric vehicle charging system and/or charging device.

Additional and/or alternative features and aspects of examples of the present technology will become apparent from the following description and the accompanying drawings.

### BRIEF DESCRIPTION OF THE DRAWINGS

The Figures generally illustrate one or more examples of an electric vehicle and/or devices for use with an electric vehicle such as electric vehicle batteries or electric vehicle charging systems and devices.

FIG. 1 is a block and schematic diagram generally illustrating an electric vehicle charging system, according to one example.

FIG. 2A is a block and schematic diagram generally illustrating an electric vehicle charging system, according to one example.

FIG. 2B is a block and schematic diagram generally illustrating an electric vehicle charging system, according to one example.

FIG. 3 is a flow diagram generally illustrating a method of charging an electric vehicle, according to one example.

FIG. 4 is a block and schematic diagram generally illustrating an electric vehicle charging system, according to one example.

FIG. 5 is a block and schematic diagram generally illustrating an electric vehicle charging system, according to one example.

### DETAILED DESCRIPTION

In the following detailed description, reference is made to the accompanying drawings which form a part hereof, and in which is shown by way of illustration specific examples in which the disclosure may be practiced. It is to be understood that other examples may be utilized and structural or logical changes may be made without departing from the scope of the present disclosure. The following detailed description, therefore, is not to be taken in a limiting sense. It is to be understood that features of the various examples described herein may be combined, in part or whole, with each other, unless specifically noted otherwise.

Electric vehicles (EVs), such as automobiles (e.g., cars and trucks), autonomous vehicles, snowmobiles, personal watercraft (PWC), all-terrain vehicles (ATVs), side-by-side vehicles (SSVs), and electric bikes, for example, offer a quiet, clean, and more environmentally friendly option to gas-powered vehicles. Electric vehicles have electric powertrains which typically include a battery system, one or more electrical motors, each with a corresponding electronic power inverter (sometimes referred to as a motor controller), and various auxiliary systems (e.g., cooling systems).

### Electric Vehicle Charging System With Battery Temperature Optimization

The range of EVs is optimized when the battery system operates at an ideal operating temperature, or within an ideal operating temperature range, such as between 20-22 degrees C., for example. Similarly, battery charging is optimized when the battery is within an ideal charging temperature range, where such optimal charging temperature range may be different for different EVs, and may be different for different types of charging operations. For example, the optimal charging temperature range may be one range for a Level 2 charging operation (e.g., 30-32 degrees C.), and another range for a DC fast charging operation (e.g., 42-44 degrees C.).

The present disclosure provides an EV charging system which operates in conjunction with an EV to ensure the EV's battery is within an optimal charging temperature range before charging the battery to thereby optimize the charge uptake of the battery. In some examples, if the EV's battery is outside of the optimal charging temperature range, the present disclosure describes powering a battery heating/cooling system from the charging station to heat/cool the battery until the battery temperature is within the optimal charging temperature range prior to beginning charging of the battery. In one case, during a charging operation, the charging station temporarily powers the battery heating/cooling system if the EV's battery has a charge level below a threshold level (e.g., less than 15% charge). In another example, during a charging operation, the charging station temporarily powers all loads of the vehicle (such as a scenario where the EV is completely without power).

One or more examples and features of the charging system are detailed herein and illustrated in the Figure(s).

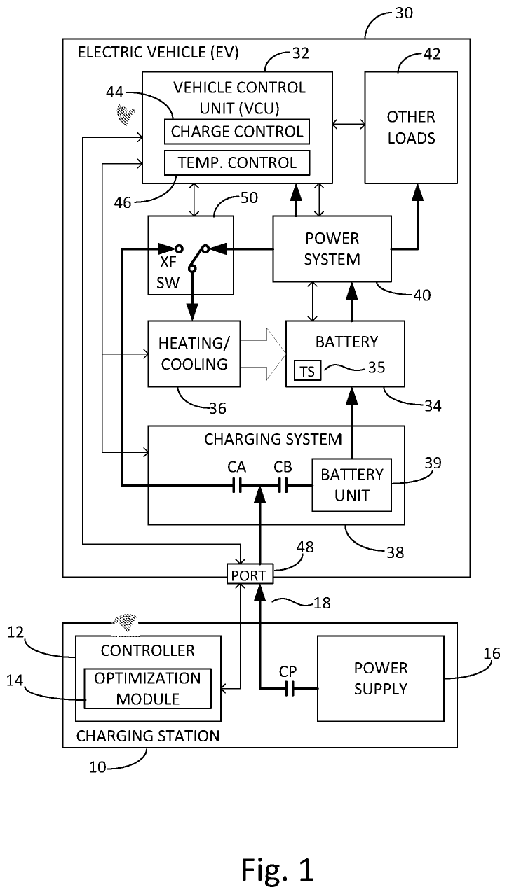

FIG. 1 is a block and schematic diagram generally illustrating a charging station 10 and an EV 30 in accordance with one example of the present disclosure. In examples, charging station 10 includes a controller 12 having an optimization module 14, and a power supply 16 for charging an EV, such as EV 10. In one example, power supply 16 is configurable to provide multiple charging outputs via sets of charging contacts, CP, wherein each output has different electrical parameters (e.g., different voltages, different current levels, including AC and DC outputs).

EV 30 includes a vehicle control unit (VCU) 32, a battery 34, a battery heating/cooling system 36, a battery charging system 38, and a power system 40 which receives power output from battery 34 and conditions, converts, and distributes power to vehicle components, such as VCU 32, battery heating/cooling system 36 (to adjust a temperature of battery 34 based on temperature measurements, such as from one or more temperature sensors (TS) 35 disposed within batter 34), charging system 38, and to other vehicle loads 42 (e.g., auxiliary loads such as air conditioning, lights, etc.). Accordingly, in examples, power system 40 may include various power converters and secondary batteries to provide various power outputs (e.g., AC and DC outputs) to power vehicle loads. In examples, VCU 32 may include a number of modules for controlling various operations of EV 30, such as charge control module 44 and battery temperature control module 46.

In accordance with one example of the present disclosure, EV 30 further includes a transfer switch 50 having an output directing power to battery heating/cooling system 36, where power is directed to battery heating/cooling system 36 from power system 40, but in some cases, as will be described in greater detail below, power is directed to battery heating/cooling system 36 from charging station 10 via charging system 38. In examples, transfer switch 30, as well a contacts CA and CB of charging system 38 may be configured to be electrically (e.g., via VCU 32) and/or manually (e.g., by hand) operated.

In one example, during a battery charging operation, upon a charging cord/plug 18 of charging station 10 being inserted into charging port 48 of EV 30, VCU 32 (e.g., via charge control module 44) communicates with controller 12 of charging station 10 to establish a charging protocol therewith (e.g., the type of charging operation to be performed and associated parameters). In one example, as part of the charging procedure, VCU 32 determines the present temperature of battery 34, such as via temperature sensors TS 35. In examples, if the present temperature of battery 34 is within the optimal charging temperature range, VCU initiates the battery charging operation by closing contact CB of charging system 38 and begins charging battery 34 via battery charging unit 39 of charging system 38. In examples, battery charging unit 39 converts and/or conditions the power input received from charging station 10 to a specified input for the charging of battery 34.

In examples, if the present temperature of the battery 34 is outside the optimal charging temperature range, VCU 32 determines a charge level of battery 34. If the charge level is above a predetermined level (e.g., 15% full charge), VCU 32, such as via temperature control module 46, directs battery heating/cooling system 36 to adjust the temperature to battery 34 (heating or cooling) to to be within the optimal charging temperature range, where power is provided to battery heating/cooling system 36 from battery 34 via power system 40 and XR SW 50. Upon the temperature of battery 34 being adjusted to be within the optimal charging temperature range, VCU 32 initiates the charging operation of battery 34 via charging system 38, wherein battery heating/cooling system 36 continues to maintain the temperature of battery 34 within the optimal charging temperature range throughout the charing procedure (e.g., the battery temperature may otherwise increase to a temperature beyond the optimal charging temperature range).

In examples, if the present temperature of the battery 34 is outside the optimal charging temperature range, and VCU 32 determines the charge level of battery 34 is below the the predetermined charge level (e.g., 15% of full charge), VCU 32 communicates with controller 12 of charging station 10 initiate a battery temperature conditioning procedure where battery heating/cooling system 36 is powered by charging station 10 to adjust the temperature of battery 34 to be within the optimal charging temperature range. According to one example, as part of the battery temperature conditioning procedure, VCU 32 communicates the electrical parameters of the power input to battery heating/cooling system 36, opens contacts CA and CB of charging system 38, and changes the position of transfer switch 50 to receive input power from charging system 38. Based on the information received from VCU 32, controller 12 of charging station 10, such as via optimization module 14, instructs power supply 16 to provide a power output to match the power input requirements of battery heating/system 36.

Upon charging station 10 providing the specified power output for battery heating/cooling system 36 at charging port 48, VCU 32 closes contact CA of charging system 38 to direct the power output from charging station 10 to battery heating/cooling system 36 via transfer switch 50. Upon battery heating/cooling system 36 adjusting the temperature of battery 34 to be within the optimal charging temperature range, VCU 32 opens contact CA of charging system 38 and switches the position of transfer switch 50 back to the normal operating position where power is directed to battery heating/cooling system 36 from power system 40. VCU 32 then signals to controller 12 of charging station 10 to begin a battery charging procedure, whereby controller 12 (such as via optimization module 14) instructs power supply 16 to provide a power output to match the power inputs requirements for a battery charging procedure of EV 10. Upon charging station 10 providing the specified power output for the charging of battery 34, VCU 32 closes contact CB to carry out the charging of battery 34 per normal charging protocols.

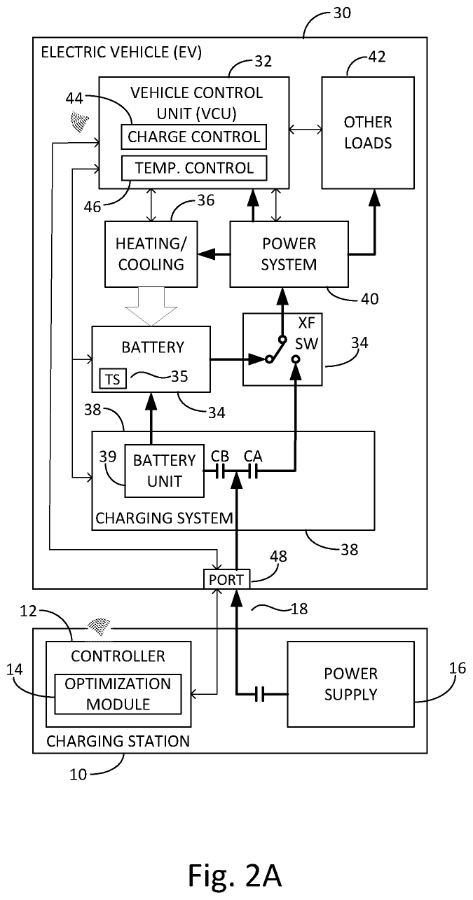

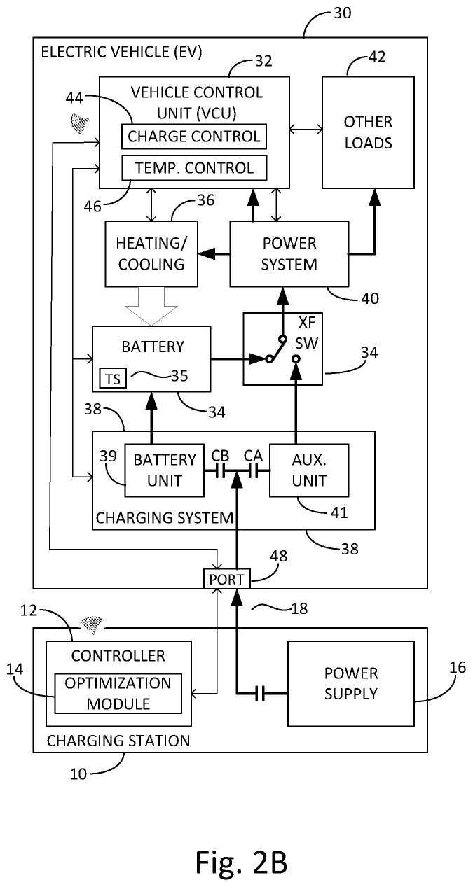

FIG. 2A is a block and schematic diagram generally illustrating charging station 10 and EV 30 in accordance with another example of the present disclosure. The implementation of FIG. 2A is similar to that of FIG. 1, except transfer switch 50 is disposed between battery 34 and charging system 38 and provides power to power system 40 in lieu of directly to battery heating and cooling system 36. As such, according to the example implementation of FIG. 2A, EV 10 is temporarily powered entirely from charging station 10 while the temperature of battery 34 is adjusted to be within the optimal charging temperature range. According to such implementation, battery 34 is able to be thermally adjusted via power provided by charging station 10 not only when battery 34 has a charge level below a predetermined threshold level, but also when EV 10 has no power whatsoever, such as during freezing conditions, where transfer switch 50 and contacts CA and CB would be electronically and/or manually operated.

In one example, during a battery charging operation, upon charging cord/plug 18 of charging station 10 being inserted into charging port 48 of EV 30, VCU 32 (e.g., via charge control module 44) communicates with controller 12 of charging station 10 to establish the charging protocol therewith (e.g., the type of charging operation to be performed and associated parameters). In one example, as part of the charging procedure, VCU 32 determines the present temperature of battery 34, such as via temperature sensors TS 35. In examples, if the present temperature of battery 34 is within the optimal charging temperature range, VCU initiates the battery charging operation by closing contact CB of charging system 38 and begins charging battery 34 via battery charging unit 38. In examples, battery charging unit 38 converts and/or conditions the power input received from charging station 10 to a specified input for the charging of battery 34.

In examples, if the present temperature of the battery 34 is outside the optimal charging temperature range, VCU 32 determines a charge level of battery 34. If the charge level is above a predetermined level (e.g., 15% full charge), VCU 32, such as via temperature control module 46, directs battery heating/cooling system 36 to adjust the temperature to battery 34 (heating or cooling) so as to to be within the optimal charging temperature range, where power is provided to battery heating/cooling system 36 from battery 34 via transfer switch 50 and power system 40. Upon the temperature of battery 34 being adjusted to be within the optimal charging temperature range, VCU 32 initiates the charging operation of battery 34 via charging system 38, wherein battery heating/cooling system 36 continues to maintain the temperature of battery 34 within the optimal charging temperature range throughout the charing procedure (e.g., the battery temperature may otherwise increase to a temperature beyond the optimal charging temperature range).

In examples, if the present temperature of the battery 34 is outside the optimal charging temperature range, and VCU 32 determines that battery 34 has some level of charge, but that the charge level is below the the predetermined charge level (e.g., 15% of full charge), VCU 32 communicates with controller 12 of charging station 10 to initiate a battery temperature conditioning procedure where battery heating/cooling system 36 is powered by charging station 10 to adjust the temperature of battery 34 to be within the optimal charging temperature range. According to one example, as part of the battery temperature conditioning procedure, VCU 32 communicates the electrical parameters of the power input to power system 40, opens contacts CA and CB of charging system 38, and changes the position of transfer switch 50 to receive input power from charging system 38 (in lieu of from battery 34). Based on the information received from VCU 32, controller 12 of charging station 10, such as via optimization module 14, instructs power supply 16 to provide a power output to match the power input requirements of battery heating/system 36 (i.e., to match the power output of battery 34).

Upon charging station 10 providing the specified power output for power system 40 at charging port 48, VCU 32 closes contact CA of charging system 38 to direct the power output from charging station 10 to power system 40 via transfer switch 50. Upon battery heating/cooling system 36 adjusting the temperature of battery 34 to be within the optimal charging temperature range, VCU 32 opens contact CA of charging system 38 and switches the position of transfer switch 50 back to the normal operating position where power is directed to battery to power system 40 from battery 34. VCU 32 then signals to controller 12 of charging station 10 to begin a battery charging procedure, whereby controller 12 (such as via optimization module 14) instructs power supply 16 to provide a power output to match the power inputs requirements for a battery charging procedure of EV 10. Upon charging station 10 providing the specified power output for the charging of battery 34, VCU 32 closes contact CB to carry out the charging of battery 34 via battery charging unit 39 per normal charging protocols.

FIG. 2B is a block and schematic diagram generally illustrating charging station 10 and EV 30 in accordance with another example. The implementation and operation of FIG. 2B is similar to that of FIG. 2A, except that in lieu of charging station 10 adjusting its power output to match the output of battery 34 during a thermal optimization procedure, charging system 38 includes an auxiliary charging unit 41 that converts the charging input from charging station 10 to match the output of battery 34.

According to such example, if the present temperature of the battery 34 is outside the optimal charging temperature range, and VCU 32 determines that battery 34 has some level of charge, but that the charge level is below the the predetermined charge level (e.g., 15% of full charge), VCU 32 communicates with controller 12 of charging station 10 to initiate a battery temperature conditioning procedure where battery heating/cooling system 36 is powered by charging station 10 to adjust the temperature of battery 34 to be within the optimal charging temperature range. According to one example, as part of the battery temperature conditioning procedure, VCU 32 opens contacts CA and CB of charging system 38, and changes the position of transfer switch 50 to receive input power from auxiliary charging unit 41 of charging system 38 (in lieu of from battery 34). Charging station 10 provides a battery charging output to charging port 30, which, via contact CA, is directed to the auxiliary charging unit 41 which, in turn, provides an output to transfer switch 50 which has the same parameters as the output of battery 34 to transfer switch 50.

Upon battery heating/cooling system 36 adjusting the temperature of battery 34 to be within the optimal charging temperature range, VCU 32 opens contact CA of charging system 38 and switches the position of transfer switch 50 back to the normal operating position where power is directed to battery to power system 40 from battery 34. VCU 32 then closes contact CB to carry out the charging of battery 34 via battery charging unit 39 per normal charging protocols.

With reference to FIGS. 2A and 2B, according to examples, in addition to be being electronically operated, transfer switch 50 and contacts CA and CB may be operated manually, such as by hand. According to one example, in a case where EV 10 has no power whatsoever, to perform a charging operation, transfer switch 50 is manually operated to connect power system 50 to charging system 38, contact CB is manually opened, and contact CA is manually closed to provide power from charing station 10 to power system 40. In FIG. 2A, the output provided by charging station 10 matched the output of battery 34. In FIG. 2B, the output provided by charing station 10 is a battery charging voltage typically provided to charge battery 34, but is converted by auxiliary converter unit to provide an input to transfer switch 50 that matches the parameters of the input from battery 34 to transfer switch 50. With the electrical systems of EV 10 thereby powered from charging station 10, VCU 10 is able to instruct battery heating/cooling system 36 to carry out a thermal optimization procedure of battery 34. Upon battery 34 having a temperature with the optimal charging temperature range, VCU 32 can initiate a charging operation of battery 34.

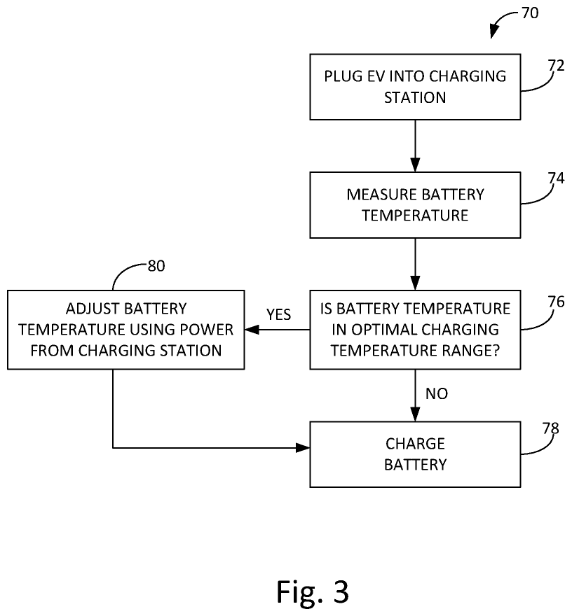

FIG. 3 is a flow diagram generally illustrating a method 70 of charging an electric vehicle, according to one example of the present disclosure. At 72, method 70 includes plugging the electric vehicle into a charging station. At 74, method 70 includes measuring a temperature of the battery. At 76, if the battery the battery temperature is within an optimal charging temperature range, method 70 proceeds to 78 where the battery is charged via the charging station. At 76, if the battery temperature is not within the optimal charging temperature range, method 70 proceeds to 80 where the battery temperature is adjusted to be within the optimal charging temperature range using power from the charging station, and then to 78 where the battery is charged.

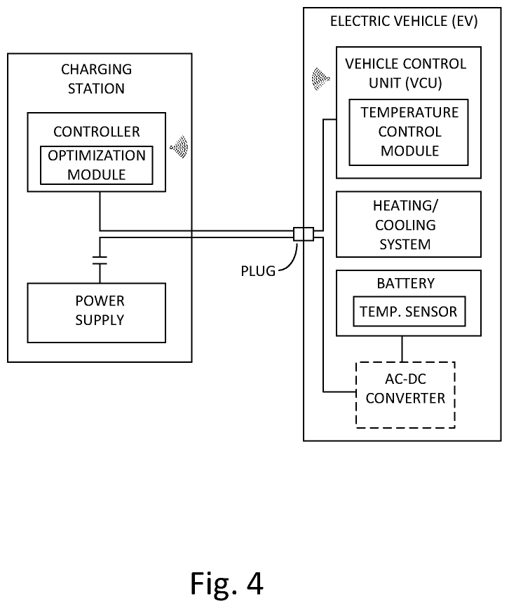

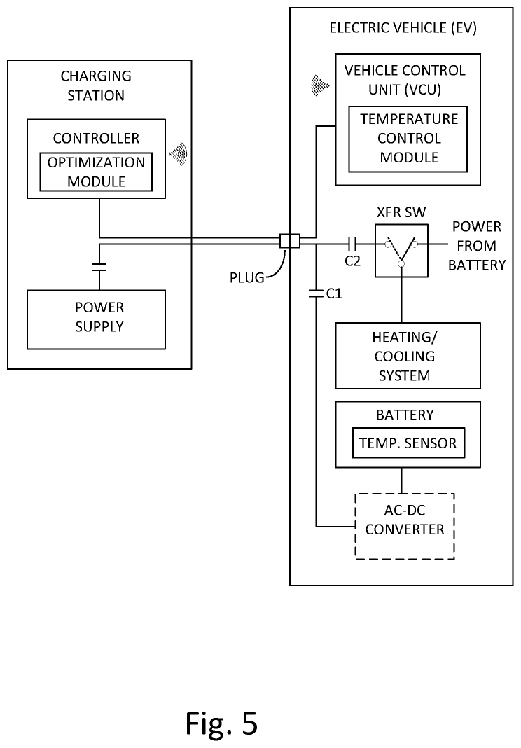

FIGS. 4 and 5 represent implementations of the present application as described below.

In one example, during an EV charging operation, upon the charging plug being inserted into the vehicle's charging port, the charging system controller communicates with the vehicle control unit to determine the ideal charging temperature range and the present temperature of the vehicle's battery. If the battery is not within an ideal charging temperature range, the charging system controller instructs the EV to begin a heating or cooling operation to adjust the battery temperature to be within the ideal charging temperature range. In examples, the EV communicates to the charging system when the battery temperature has reached the ideal charging temperature range, and the charging system begins charging the battery. In some examples, the charging station periodically requests the battery temperature during the heating/cooling process (e.g., every 10 seconds, or any suitable time) to determine when the battery is within the ideal charging temperature range.

In one example, rather than the charging station automatically initiating a battery temperature optimization charging protocol/procedure, such charging procedure is user selectable whereby upon plugging the charging plug into the vehicle's charging port, the user is queried by the charging station (such as via a user interface) whether the driver would like to employ the battery temperature optimization charging procedure, or would simply prefer to charge the vehicle at at the current battery temperature (e.g., an additional fee may apply for a battery temperature optimization charging procedure).

In one example, upon initiating a battery temperature optimization procedure, the charging station requests the current battery charge level from the EV. If the charge level is too low to carry out a heating/cooling operation of the battery, the charging station may bypass the battery temperature optimization process and charge the battery at its current temperature. In other examples, the charging station may start the charging process with the battery at the current temperature, and upon the battery reaching a charge level threshold at which the EV may carry out a battery temperature optimization procedure, to implement the battery temperature optimization charging procedure and resume the charging procedure after the battery has reached the battery charging temperature range.

In other examples, if the charge level of the EV battery is too low to carry out a temperature adjustment procedure, in order to perform a battery temperature optimization charging procedure, the charging station provides electrical power to operate the EV's battery heating/cooling system (rather than the heating/cooling system being powered from the EV's battery). The VCU then carries out a heating/cooling process to adjust the battery temperature to be within the optimal temperature range while powered from the charging station. In one example, the EV includes a transfer switch (XFR SW) via which the VCU selectively controls the power source from which the heating/cooling system is powered (i.e., via the EV's battery or the charging station). In examples, such as when an EV has no battery power

In a case where the heating cooling system is to be powered from the charging station, the VCU opens contractor C1 (to interrupt the connection between the charging station and the battery), closes contactor C2 (to connect the charging station to the transfer switch), and selectively switches the charging station as the power source for the heating/cooling system via operation of XFR SW. Upon the heating/cooling system adjusting the battery temperature to be within the ideal operating temperature range, the VCU opens contactor C2, operates the XFR SW to select the battery as the power source for the heating/cooling system, and closes contact C1 to being charging the battery from the charging station. In one example, control power for controlling the operation of the EV, including the VCU, continues to be provided from the EV's battery, even when the heating/cooling system is powered from the charging station.

In another examples, when the battery charge level is below a threshold level, the charging station may charge the EV's battery while the VCU simultaneously operates the heating/cooling system to adjust the battery temperature so as to be in the ideal operating temperature range.

In examples, the charging station may communicate with the EV via control pathways in the charging cable, or may wirelessly communicate with the EV.

It is recognized that the charging system of the present disclosure can be configured for use in many charging system applications, including those not disclosed herein.

Although specific examples have been illustrated and described herein, a variety of alternate and/or equivalent implementations may be substituted for the specific examples shown and described without departing from the scope of the present disclosure. This application is intended to cover any adaptations or variations of the specific examples discussed herein.

The claims are part of the specification.

1. A method of charging a battery of an electric vehicle comprising:
plugging the electric vehicle into a charging station;
measuring a temperature of the battery; and
adjusting the temperature of the battery to be within a charging temperature range using power supplied from the charging station.

2. The method of claim 1, including:
charging the battery after the battery temperature is within the charging temperature range.

3. The method of claim 1, wherein adjusting the temperature of the battery includes heating and or cooling the battery.

4. The method of claim 1, including:
adjusting electrical parameters of the power provided by the charging station to the electrical vehicle to match power requirements of a vehicle heating and cooling system.

5. The method of claim 4, wherein plugging the electric vehicle into the charging station includes plugging the charging plug into a charging port of the electric vehicle; the method including:
operating a transfer switch of the electric vehicle to transfer power to the heating and cooling system from the electric vehicle battery to power provided by the charging station via the charging port.

6. The method of claim 1, including:
adjusting electrical parameters of the power supplied by the charging station to match electrical parameters of the electric vehicle battery output when the battery temperature is outside of the charging temperature range and a charge level of the electric vehicle battery is below a first charge level.

7. The method of claim 6, wherein plugging the electric vehicle into the charging station includes plugging the charging plug into a charging port of the electric vehicle; the method including:
operating a transfer switch of the electric vehicle to transfer power to operate the electric vehicle from the electric vehicle battery to power provided by the charging station via the charging port.

8. The method of claim 1, wherein adjusting the temperature of the battery includes:
powering a battery heating and cooling system of the electric vehicle with the power supplied from the charging station if the measured temperature is outside of a predetermined charging temperature range and a state of charge of the battery is less than a predetermined charge level.

9. The method of claim 8, further including electrically isolating the electric vehicle battery from the power supplied from the charging station.

10. The method of claim 8, including:
adjusting electrical parameters of the power supplied by the charging station to the electric vehicle to match electrical parameters of a vehicle heating and cooling system when the battery temperature is outside of the charging temperature range and the charge level of the electric vehicle battery is above a first charge level; and
adjusting electrical parameters of the power supplied by the charging station to the electric vehicle to match electrical parameters of the electric vehicle battery output when the battery temperature is outside of the charging temperature range and the charge level of the electric vehicle battery is below the first charge level.

11. The method of claim 10, upon the battery temperature being adjust to be within the charging temperature ranged, the method including:
adjusting the electrical parameters of the power supplied by the charging station to match electrical parameters of the electric vehicle for charging the battery; and
charging the battery.

12. An electric vehicle (EV) charging station comprising:
a power supply to provide an adjustable power output having controllable electrical parameters;
a charging cable to plug into an EV to provide the power output from the power supply to the EV;
a charging station controller to communicate with the EV to determine a temperature and a charge level of a battery of the EV, if the temperature is outside of a charging temperature range and the charge level is below a threshold level, the station controller to direct the power supply to provide to the EV a power output having electrical parameters to enable the EV to adjust the battery temperature to be within the charging temperature range using the power output from the EV charging station.

13. The EV charging station of claim 12, wherein the electrical parameters of the power output to enable the EV to adjust the battery temperature are different from electrical parameters of a power output provided to the EV by the power supply to charge the EV battery.

14. The EV charging station of claim 12, wherein the electrical parameters of the power output match electrical parameters of power input requirements of a battery heating and cooling system of the EV.

15. The EV charging station of claim 12, wherein the electrical parameters of the power output match the electrical parameters of the power output from the battery of the EV.

16. The EV charging station of the claim 12, wherein the electrical parameter of the power output at least include a voltage type and a voltage magnitude, wherein the voltage type includes direct current and alternating current, and a number of phases of alternating current.

17. The EV charging station of claim 12, wherein the EV charging station communicates with the EV wirelessly and/or via the charging cable.
